(19) United States
(12) Patent Application Publication
(10) Pub. No.: US 2026/0361511 A1
(43) Pub. Date: Nov. 12, 2026

(54) MULTIPARTY UNIQUE KEY PER TRANSACTION (CRYPT)

(71) Applicant: Wells Fargo Bank, N.A., San Francisco, CA (US)

(72) Inventors: Jeffrey J. Stapleton, O'Fallon, MO (US); Kelle Lynn Clark, Weddington, NC (US)

(73) Assignee: Wells Fargo Bank, N.A., San Francisco, CA (US)

(21) Appl. No.: 19/202,415

(22) Filed: May 8, 2025

(51) Int. Cl. H04L 9/08; H04L 9/14

(52) U.S. Cl. CPC H04L 9/0816; H04L 9/0877; H04L 9/14

(57) ABSTRACT

The arrangements disclosed herein relate to systems, apparatus, methods, and non-transitory computer readable media for deriving an Initial Key (IK) using an identifier of a sender, a plurality of identifiers each corresponding to a respective one of a plurality of receivers, and a Domain Key (DK), deriving a first transaction key using the IK and a counter corresponding to a first transaction and provide the first transaction key to the sender, deriving the IK using the identifier of the sender, and deriving the first transaction key using the IK and the received counter corresponding to the first transaction and provide the first transaction key to each of the plurality of receivers.

### BACKGROUND

key management systems are preferably interoperable and evaluated, whereas proprietary key management solutions which are not based on industry standards make interoperability challenging. For example, proprietary key management solutions may not be evaluated to the satisfaction of the participants. Another issue, proprietary key management solutions might be protected as intellectual property.

### SUMMARY

The arrangements disclosed herein relate to systems, methods, non-transitory computer-readable media, and apparatuses for deriving an Initial Key (IK) using an identifier of a sender, a plurality of identifiers each corresponding to a respective one of a plurality of receivers, and a Domain Key (DK), deriving a first transaction key using the IK and a counter corresponding to a first transaction and provide the first transaction key to the sender, the sender encrypts a first message using the first transaction key and sends the encrypted first message and the counter to the plurality of receivers via a network, deriving, for each of the plurality of receivers, the IK using the identifier of the sender, the plurality of identifiers each corresponding to the respective one of the plurality of receivers, and the DK, and deriving the first transaction key using the IK and the received counter corresponding to the first transaction and provide the first transaction key to each of the plurality of receivers, wherein each of the plurality of receivers decrypts the first message using the first transaction key.

These and other features, together with the organization and manner of operation thereof, will become apparent from the following detailed description when taken in conjunction with the accompanying drawings.

### BRIEF DESCRIPTION OF THE DRAWINGS

FIG. 1 is a schematic block diagram illustrating an example Multiparty Unique Key Per Transaction (CRYPT) scheme, according to some arrangements.

FIG. 2 is a block diagram of an example of a sender, a receiver, and a computing system for a manager, according to some arrangements.

FIG. 3 is a flow diagram illustrating a method for communicating a message using the CRYPT scheme, according to various arrangements.

### DETAILED DESCRIPTION

Conventional symmetric schemes such as Derived Unique Key Per Transaction (DUKPT) is limited to one-to-one communications, such as from a Point of Sale (POS) terminal or an Automatic Teller Machine (ATM) to a host. For example, in conventional DUKPT implementations, only one identifier, e.g., the Terminal Identifier (TID) is needed for both the terminal and the host to derive the same symmetric key. Conventional techniques for symmetrical key derivation do not allow multiple parties (e.g., one sender sending a message to multiple receivers) to derive symmetric keys. Given that multiple parties are present in the communication, a strong authentication and authorization over the entire schema, which has not been previously contemplated, is needed.

The arrangements described herein relate to a CRYPT scheme that can be implemented for any symmetric-based cryptographic functions for a domain, including encryption, message authentication, tokenization, and Random Number Generation (RNG) systems. The CRYPT scheme applies toward multiple parties in a domain to provide improved interoperability and is evaluated to the satisfaction of the multiple participants. For example, CRYPT supports multicast to a Community of Interest (COI). Unlike DUKPT which is unilateral, CRYPT is bidirectional. Accordingly, CRYPT provides a strong authentication and authorization multiparty key derivation scheme that is previously unavailable.

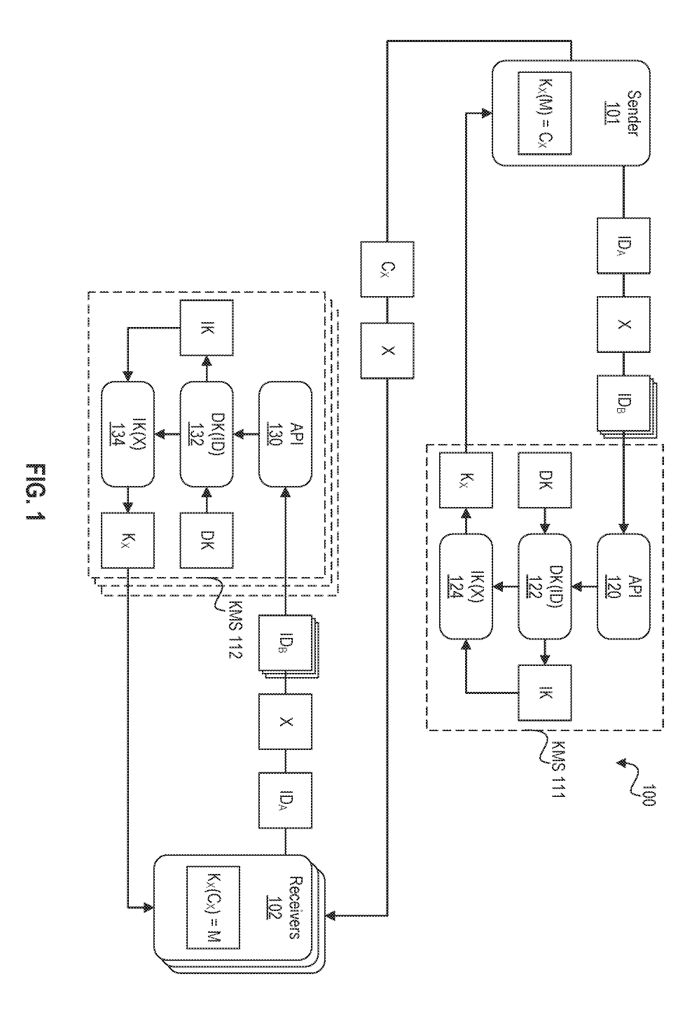

FIG. 1 is a block diagram illustrating an example CRYPT scheme 100 (e.g., the CRYPT method or CRYPT system), according to some arrangements. The system for implementing the CRYPT scheme 100 includes at least a sender 101, multiple receivers 102, Key Management Services (KMSs) 111 and 112. The sender 101 refers to a first computing system (e.g., device, server, and so on). Each receiver 102 refers to a second computing system (e.g., device, server, and so on). For example, the sender 101 or each receiver 102 includes a computing system having processing, storage, and networking capabilities to execute functions, software, or firmware to perform methods, processes and operations disclosed herein.

In some implementations, the sender 101 (e.g., a first party) and the receivers 102 (e.g., a second party, a third party, …, an Nth party) are parties, users, devices, and computing systems within a same domain. The receivers 102 that are in the same domain are in the COI, which has a directory service as described herein. In other words, the sender 101 and the receivers 102 are part of a centralized network managed under a single administrative framework. For example, a domain of the sender 101 and the receivers 102 can be controlled by a directory service that allows administrators to enforce security policies, manage user access, and oversee encryption protocols across all devices in the domain. The administrative framework can provide the KMSs 111 and 112 to facilitate with the key derivation. The sender 101 and the receivers 102 being in the same domain ensures that they can securely share encryption keys, authenticate users, verify data, and apply consistent security measures. The domain can also simplify tasks such as deploying updates (e.g., HMAC for software code sign using a symmetric key), managing recovery keys, and ensuring compliance with organizational security standards. The KMSs 111 and 112 can create a unified and secure environment for managing devices and data within the domain.

In some implementations, the sender 101 (e.g., a first party) and at least some of the receivers 102 (e.g., a second party, a third party, …, an Nth party) are parties, users, devices, and computing systems within different domains. In other words, the sender 101 and the at least some of the receivers 102 are part of different centralized networks managed under different administrative frameworks. For example, sender 101 belongs to a first domain D1 and a receiver 102 belongs to a second domain (D2). A bridge (B) (e.g., a secure server) between the domains D1 and D2 has both domain keys and can derive IK1 (X) = K1 and IK2 (X) = K2 to translate the cipher C1 to C2 across the different domains.

The sender 101 is operatively coupled to or includes the KMS 111. Each receiver 102 is operatively coupled to or includes a respective one of the KMS 112. Each of the KMSs 111 and 112 refers to a functions, software, or firmware configured to perform methods, processes and operations disclosed herein. The KMS 111 includes a Application Programming Interface (API) 120 and operations 122 and 124. The API 120 is used to receive data from the sender 101 and forward the data to the rest of the KMS 111. Each KMS 112 includes an API 130 and operations 132 and 134. The API 130 is used to receive data from the sender receiver 102 and forward the data to the rest of the KMS 112. In some arrangements, the KMSs 111 and 112 are the same (e.g., the APIs 120 and 130 are same) under the domain. In some arrangements, the KMS 111 may be executed on a computing system separate from that on which the methods, processes and operations disclosed herein with respect to the sender 101 are performed. In some arrangements, each KMS 112 may be executed on a computing system separate from that on which the methods, processes and operations disclosed herein with respect to a corresponding receiver 102 are performed. In some arrangements, the KMS 111 may be executed on a computing system on which the methods, processes and operations disclosed herein with respect to the sender 101 or one or more receivers 102 are performed (e.g., the KMS 111 may be an application or program installed on the sender 101 or the receivers 102). In some arrangements, the KMS 112 may be executed on a computing system on which the methods, processes and operations disclosed herein with respect to the sender 101 or one or more receivers 102 are performed (e.g., the KMS 112 may be software, application, or program installed on the sender 101 or the receivers 102). In other words, each of the KMSs 111 and 112 includes functions, software, or firmware running on the sender 101, one or more receivers 102, or a computing device separate from both the sender 101 and the receivers 102. Accordingly, flexibility in deployment can be provided for the KMSs 111 and 112. In the examples in which a KMS 111 or 112 is provided to the sender 101 or a receiver 102 to be executed using the same computing system as software, application, or program, communications between the KMS 111 or 112 and the other functions of the sender 101 or a receiver 102 can be performed via suitable Application Protocol Interfaces (APIs).

In some arrangements, communications among the sender 101, the receivers 102, the KMSs 111 and 112 (if implemented using computing system(s) separate from the sender 101, the receivers 102) can be performed over a network. The network can be any suitable Local Area Network (LAN), Wide Area Network (WAN), or a combination thereof. For example, the network can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1x Radio Transmission Technology (1x), General Packet Radio Service (GPRS), Personal Communications Service (PCS), 802.11X, ZigBee, Bluetooth, Wi-Fi, any suitable wired network, combination thereof, and/or the like. The network is structured to permit the exchange of data, values, instructions, messages, and the like.

In the CRYPT scheme 100, the sender 101 and the receivers 102 share a Domain Key (DK) with the KMSs 111 and 112 by virtue of being in the same domain. For example, the KMS 111 is a Hardware Security Module (HSM) that secures or stores the DK, and each KMS 112 is an HSM that secures or stores the DK.

The sender 101 is configured to send a protected (e.g., encrypted) message to the multiple receivers 102 via the network. The sender 101 provides to the KMS 111 (via the network or via the API) an identifier ID_{A} of the sender 101, a counter X, and a list of identifiers for the receivers 102 (e.g., an identifier ID_{B} of each of the receivers 102) to obtain the transaction key K_{X}. In some examples, the list of receivers can be restricted to a pre-authorized list for the domain so that the sender 101 cannot purposely or inadvertently leak the list to an unauthorized receiver 102. In some examples, the counter X can be a number incremented by the sender 101, a random number generated by the sender 101 or another random number generator, or a timestamp generated by the sender 101 or another time stamp authority. The counter can be incremented or the random number/timestamp can be generated in response to determining that the sender 101 is sending the message M to the receivers 102. In the examples in which the counter X includes a timestamp, the KMS 111 ensures that an older timestamp is not reused.

The KMS 111 via the API 120 can generate a unique key per transaction K_{X} corresponding to the transaction identified by the counter X. For example, the KMS 111 uses the DK with the sender identifier ID_{A} and the list of receiver identifiers ID_{B} to derive an Initial Key (IK) with an HSM, at 122. In some examples, the KMS 111 combines the sender identifier ID_{A} and the list of receiver identifiers ID_{B} into a single parameter ID. For example, the parameter ID can be generated by performing a bitwise XOR for the sender identifier ID_{A} and the list of receiver identifiers ID_{B}, e.g., ID_{A} is XORed first ID_{B}, the result is XORed with second ID_{B}, …, the result isXORed with the last ID_{B}. In yet another example, the parameter ID can be generated by concatenating all or a portion of each of the sender identifier ID_{A} and the list of receiver identifiers ID_{B} together. Other suitable techniques can be used to aggregate or combine the sender identifier ID_{A} and the list of receiver identifiers ID_{B} together to form the ID.

The KMS 111 derives the IK using the DK and combined parameter ID. For example, the KMS 111 generate the IK using a first function, by inputting the combined ID and the DK into the first function, which outputs the IK. In some examples, the first function includes a Key Derivation Function (KDF). In other examples in which the sender identifier ID_{A} and the list of receiver identifiers ID_{B} are not combined, the DK and ID_{A} are inputted into the first function, which outputs a first key, then the first intermediate key and first ID_{B} areinputted into the first function, which outputs a second intermediate key, …, the previous intermediate key and the last ID_{B} are inputted into the first function, which outputs the IK. In some examples in which ID_{A} is a member of a domain with multiple members (e.g., ID_{B}, ID_{C}, etc.) and that the domain is its own ID ID₁ then ID₁ can be used instead of ID_{A}. The IK is a symmetric algorithm key that is sufficiently strong and thus can be quantum-resistant.

The KMS 111 can use the IK with the counter X to derive transaction key K_{X} with an HSM at 124 and sends the transaction key K_{X} to the sender 101 in a secured manner (e.g., via a secure connection or channel over the network or via a secure API). For example, the KMS 111 can run the IK through a second function a number of times as indicated by the counter X. For example, the IK is run through the second function a first time to determine an intermediate key, which is run through the second function a second time to determine an updated intermediate k, until the intermediate key from the iteration X-1 is run through the second function the Xth time to determine the final key. In some examples, the final key is the transaction key K_{X}. In other examples, the final key is run through a third function to generate the transaction key K_{X}. After the KMS 111 generates the transaction key K_{X}, the KMS 111 erases the IK and any intermedia keys generated.

In some examples, each of the first function, the second function, and the third function can be a different function. In some examples, two or more of the first function, the second function, and the third function can be a same function. In some examples, each of the first function, the second function, and the third function can include a hash algorithm or a one-way function.

The sender 101 protects a message M using K_{X} for the transaction identified by the counter X to determine the ciphertext C_{X}. The sender 101 sends to each of the receivers 102 via the network, the counter X and the ciphertext C_{X}.

In response to receiving the counter X and the ciphertext C_{X}, each receiver 102 provides to the KMS 112 (via the network or via the API) the received identifier ID_{A} of the sender 101, the received counter X, and the list of identifiers for the receivers 102 (e.g., an identifier ID_{B} of each of the receivers 102) to obtain the transaction key K_{X}. Each KMS 112 generates the same unique key per transaction K_{X} corresponding to the transaction identified by the counter X. The operations performed by each KMS 112, e.g., at 132 and 134, is the same as those performed by the KMS 111, e.g., at 122 and 124 respective, to generate the same transaction key K_{X}. Thus, the description of 132 and 134 is omitted for the sake of brevity. After each KMS 112 generates the transaction key K_{X}, each KMS 112 sends the transaction key K_{X} to a corresponding receiver 102 in a secured manner (e.g., via a secure connection or channel over the network or via a secure API) and erases the IK and any intermedia keys generated. Each receiver 102 uses the transaction key K_{X} to decrypt the ciphertext C_{X} and recover the message M.

The transaction key K_{X} is used once by the sender 101 to encrypt the message M and once by the receiver 102 to decrypt the message M. For a subsequent transaction X+1, the method repeats with the counter being X+1 (or another random number or another timestamp), which would yield a different K_{X} for that transaction. Each participant uses an HSM in the KMS to protect the DK, the derived group IK, and the transaction key K_{X}.

A symmetric key refers to a cryptographic key that is identical for the sender 101 and the receivers 102 per transaction of a data transmission. The sender 101 can encrypt the message or generates a Message Authentication Code (MAC) or Hash-based Message Authentication Code (HMAC) for integrity and authentication. Both the sender 101 and the receivers 102 must have the same key (e.g., the symmetric key) for the data to be transmitted to the receivers 102 such that the receivers 102 can either decipher the encrypted data, encrypted by the sender 101, or verify a HMAC or a MAC, generated by the sender 101. Although from the perspective of a single receiver 102, the communication can be deemed as a one-to-one communication, in order to improve the cryptographic strength of the scheme, the IDs of all receivers 102 in a domain are included in deriving the transaction key. Thus, even if certain receivers are compromised, an attacker nevertheless would not be able to derive the transaction key without knowledge of the other receivers in the domain.

The message M communicated between the sender 101 and the receivers 102 via the network (e.g., a communication session thereof) can be any type of information that needs protection during transmission. Examples of such message can include emails, data, virtual machine application data, banking client data, data communicated using the internet or web browser, etc.

In the CRYPT scheme, the IK can be derived for two or more parties (e.g., the sender 101 and the receivers 102), and is unique per the ID subgroup (e.g., the domain) specified by the sender 11 to obtain the transaction key K_{X}. In some examples, instead of erasing the IK, the IK can be derived by one of the sender 101 or receivers 102 to encrypt local or database storage, and reused by the single party to decrypt at a later time, in order to reduce resource consumption and time required to implement the CRYPT scheme.

Each ID in the list of receiver IDs ID_{B} is a unique ID within the domain and can be managed by a group list, or a subgroup list, to allow efficient enterprise management. In some examples, instead of sending the list of receiver IDs ID_{B} to the KMS 111, the sender 101 can send a domain ID (e.g., a group ID) to the KMS 111, which can look up the associated receiver IDs ID_{B} mapped to the domain ID. In some examples, instead of using the combined receiver IDs to derive IK at 122 and 132, the domain ID can be used instead, to reduce computational complexity and conserve resources. Each of the IDs ID_{A} and ID_{B} can be unique ID such as a username, account number, email address, device identifier, device identifier (e.g., International Mobile Equipment Identity (IMEI), or another Globally Unique Identifier (GUID).

In some examples, the ID for the sender 101 or a receiver 102 can be used for authentication of the device of the sender 101 or the receiver 102. For example, in response to receiving the ID_{A} of the sender 101, the KMS 111 authenticates the sender 101 using ID_{A}. In response to successfully authenticating the sender 101 using the ID_{A} (e.g., the sender 101 is authorized to use the KMS 111 and/or to send to the receivers 102), the KMS 111 derives the transaction key K_{X} in the manner described. Otherwise, the KMS 111 does not derive the transaction key K_{X} and returns a failure notification. For example, in response to receiving the ID_{B} of a receiver 102, the KMS 112 authenticates the receiver 102using ID_{B}. In response to successfully authenticating the receiver 102 using the ID_{B} (e.g., the receiver 102 is authorized to use the KMS 111 and/or to receive from the sender 101), the KMS 112 derives the transaction key K_{X} in the manner described. Otherwise, the KMS 112 does not derive the transaction key K_{X} and returns a failure notification.

In some examples, the list of ID_{B} of the receivers 102 can be used for authentication whether a group message request (e.g., a request to send a message to the group of receivers 102) is allowable. For example, in response to receiving the list of ID_{B} of the receivers 102, the KMS 111 verifies whether message to the group of receivers 102 is allowed using list of ID_{B} of the receivers 102 (e.g., by comparing the list of ID_{B} of the receivers 102 against a prestored list of allowed receivers). In response to successfully verifying list of ID_{B} (e.g., each ID_{B} in the list is allowed to receive the message), the KMS 111 derives the transaction key K_{X} in the manner described. Otherwise, the KMS 111 does not derive the transaction key K_{X} and returns a failure notification.

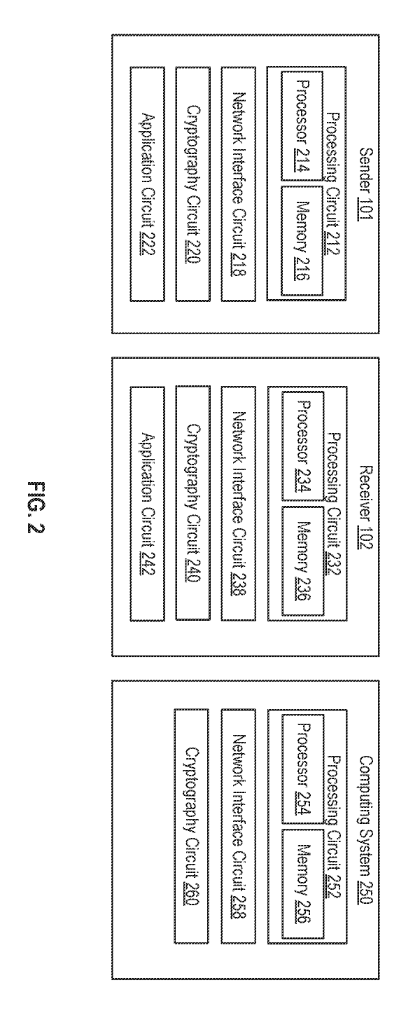

FIG. 2 is a block diagram of an example of the sender 101, the receiver 102, and the computing system 250, according to some arrangements. Referring to FIGS. 1-2, the functions described herein of the sender 101 is performed using a computing system of the sender 101 as shown in FIG. 2. The functions described herein of the receiver 102 is performed using a computing system of the receiver 102 shown in FIG. 2. The computing system 250 is configured to implement the KMS 111 or 112, in the examples in which the KMS 111 or 112 is implemented using a computing system separate from the sender 101 and the receiver 102.

The sender 101 is shown to include various circuits and logic for implementing the operations described herein. The sender 101 includes one or more of a processing circuit 212, a network interface circuit 218, a cryptography circuit 220, and an application circuit 222. While various circuits, interfaces, and logic with particular functionality are shown, it should be understood that the sender 101 includes any number of circuits, interfaces, and logic for facilitating the operations described herein. For example, the activities of multiple circuits are combined as a single circuit and implemented on a same processing circuit (e.g., the processing circuit 212), as additional circuits with additional functionality are included.

In some arrangements, the processing circuit 212 includes a processor 214 and a memory 216. The processor 214 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 216 (e.g., Random Access Memory (RAM), Read-Only Memory (ROM), Non-Volatile RAM (NVRAM), Flash Memory, hard disk storage, etc.) stores data and/or computer code for facilitating the various processes described herein. Moreover, the memory 216 is or includes tangible, non-transient volatile memory or non-volatile memory. Accordingly, the memory 216 includes database components, object code components, script components, or any other type of information structure for supporting the various activities and information structures described herein. The processing circuit 212 can be used to implemented one or more of the circuits 218, 220, and 222.

The network interface circuit 218 is configured for and structured to establish a connection and communicate with the receiver 102 and/or the computing system 250 via the network described herein or another a suitable wired, wireless, or physical connection. The network interface circuit 218 is structured for sending and receiving data over a communication network (e.g., the network over which a communication session is established) or a physical connection (e.g., via a physical connector such as Universal Serial Bus (USB)). Accordingly, the network interface circuit 218 includes any of a cellular transceiver (for cellular standards), wireless network transceiver (for 802.11X, ZigBee, Bluetooth, Wi-Fi, or the like), wired network interface, or a combination thereof. For example, the network interface circuit 218 may include wireless or wired network modems, ports, baseband processors, and associated software and firmware.

The application circuit 222 can be used to execute one or more client-side applications or software on the sender 101 for which message needs to be transmitted to the receivers 102. For example, the application circuit 222 can execute an email client, a mobile banking application, a browser, a word processing application, a mobile banking application, a mobile wallet, a File Transfer Protocol (FTP) client, a virtual machine application, administrator platform, and so on.

The cryptography circuit 220 is executed by the processing circuit 212 in some arrangements. The cryptography circuit 220 performs cryptographic operations of or embodies the at least one of the sender 101, such as encrypting the message using the transaction key. The cryptography circuit 220 can further perform the functions of the KMS 111, in the examples in which the KMS 111 is deployed as software or firmware on the sender 101. The sender 101 can provide the cryptography circuit 220 in various manners. In some arrangements, the cryptography circuit 220 is a server-based application executable on the sender 101. In this regard, the user of the sender 101 has to download the cryptography circuit 220 from an application download server prior to usage. In some arrangements, the cryptography circuit 220 is a web-based interface application provided by an application server. In some arrangements, the cryptography circuit 220 includes an API and/or an SDK provided by the application server that facilitates integration with other applications. In some arrangements, the cryptography circuit 220 is coded into the memory 216 of the sender 101. All such variations and combinations are intended to fall within the spirit and scope of the present disclosure.

The receiver 102 is shown to include various circuits and logic for implementing the operations described herein. More particularly, the receiver 102 includes one or more of a processing circuit 232, a network interface circuit 238, a cryptography circuit 240, and an application circuit 242. While various circuits, interfaces, and logic with particular functionality are shown, it should be understood that the receiver 102 includes any number of circuits, interfaces, and logic for facilitating the operations described herein. For example, the activities of multiple circuits are combined as a single circuit and implemented on a same processing circuit (e.g., the processing circuit 232), as additional circuits with additional functionality are included.

In some arrangements, the processing circuit 232 has a processor 234 and memory 236. The processor 234 is a processing component such as the processor 214. The memory 236 is a memory device such as the memory 216. The processing circuit 232 can be used to implemented one or more of the circuits 238, 240, and 242.

The network interface circuit 238 is a network device such as the network interface circuit 218. The network interface circuit 238 is configured for and structured to establish a connection and communicate with the sender 101 and/or the computing system 250 via the network described herein or another a suitable wired, wireless, or physical connection.

The application circuit 242 can be used to execute one or more server-side applications or software on the receiver 102 for which the message needs to be received by the receiver 102. For example, the application circuit 242 can execute an email server, a mobile banking application server, a website, a word processing application server, a mobile banking application server, a mobile wallet server, an FTP server, a virtual machine server, and so on.

The cryptography circuit 240 is executed by the processing circuit 232 in some arrangements. In some arrangements, the cryptography circuit 240 can perform cryptographic operations of or embodies the at least one of the receiver 102, such as decrypting the received encrypted message. The cryptography circuit 240 can further perform the functions of the KMS 112, in the examples in which the KMS 112 is deployed as software or firmware on the receiver 102. The receiver 102 can provide the cryptography circuit 240 in various manners. The cryptography circuit 240 can further perform the functions of the KMS 111, in the examples in which the KMS 111 is deployed as software or firmware on the sender 101. In some arrangements, the cryptography circuit 240 is a server-based application executable on the receiver 102. In this regard, the user of the receiver 102 has to download the cryptography circuit 240 from an application download server prior to usage. In some arrangements, the cryptography circuit 240 is a web-based interface application provided by an application server. In some arrangements, the cryptography circuit 240 includes an API and/or an SDK provided by the application server that facilitates integration with other applications. In some arrangements, the cryptography circuit 240 is coded into the memory 236 of the receiver 102. All such variations and combinations are intended to fall within the spirit and scope of the present disclosure.

The computing system 250 is shown to include various circuits and logic for implementing operations described herein. More particularly, the computing system 250 includes one or more of a processing circuit 252, a network interface 258, and a cryptography circuit 260. While various circuits, interfaces, and logic with particular functionality are shown, it should be understood that the computing system 250 includes any number of circuits, interfaces, and logic for facilitating the operations described herein. For example, the activities of multiple circuits are combined as a single circuit and implemented on a same processing circuit (e.g., the processing circuit 252), as additional circuits with additional functionality are included.

In some arrangements, the processing circuit 252 has a processor 254 and memory 256. The processor 254 is a processing component such as the processor 214. The memory 256 is a memory device such as the memory 216. The processing circuit 252 can be used to implemented one or more of the circuits 258 and 260.

The network interface circuit 258 is a network device such as the network interface circuit 218. The network interface circuit 258 is configured for and structured to establish a connection and communicate with the sender 101 and/or the receiver 102 via the network described herein or another suitable wired, wireless, or physical connection.

The cryptography circuit 260 is executed by the processing circuit 252 in some arrangements. The cryptography circuit 260 is configured to perform the operations of the KMS 111 or 112, such as generating the IK and the transaction key, in the manner described.

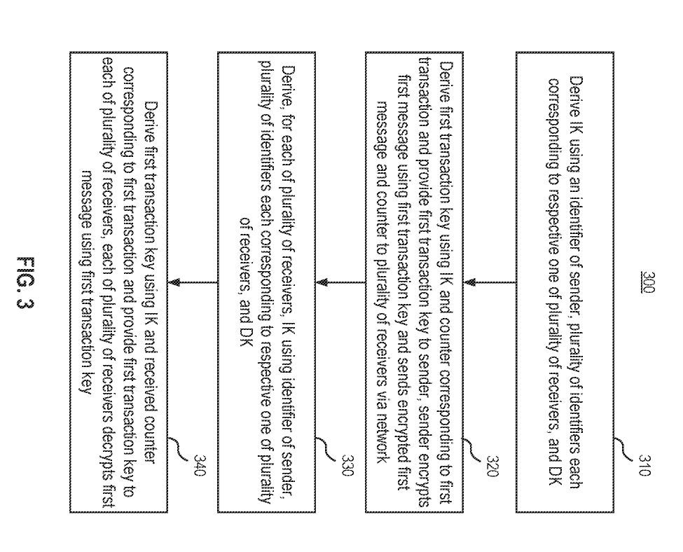

FIG. 3 is a flow diagram illustrating a method 300 for communicating a message using the CRYPT scheme, according to various arrangements. The method 300 can be performed by the sender 101, the receivers 102, and the KMSs 111/112. In some examples, the sender 101 and the plurality of receivers 102 are in a same domain.

At 310, at least one KMS (e.g., the KMS 111) derives an IK using an identifier D_{A} of a sender 101, a plurality of identifiers ID_{B} each corresponding to a respective one of a plurality of receivers 102, and a DK. At 320, at least one KMS (e.g., the KMS 111) derives a first transaction key K_{X} using the IK and a counter X (corresponding to a first transaction), and provides the first transaction key K_{X} to the sender 101. The sender 101 encrypts a first message M using the first transaction key K_{X} and sends the encrypted first message C_{X} and the counter X to the plurality of receivers 102 via a network.

At 330, at least one KMS (e.g., a KMS 112) derives, for each of the plurality of receivers 102, the IK using the identifier ID_{A} of the sender 101, the plurality of identifiers ID_{B} each corresponding to the respective one of the plurality of receivers 102, and the DK. Each receiver 102 has its own KMS 112, in the manner described herein. At 340, at least one KMS (e.g., the KMS 112) derives the first transaction key K_{X} using the IK and the received counter X corresponding to the first transaction and provides the first transaction key K_{X} to each of the plurality of receivers 102. Each of the plurality of receivers 102 decrypts the encrypted first message using the first transaction key K_{X}.

In some examples, the at least one KMS (includes a single KMS e.g., the KMS 111 and all the KMSs 112 are a same KMS) operatively coupled to both the sender 101 101 and the plurality of receivers 102. The single KMS serves as a central service to the sender 101 and the plurality of receivers 102.

In some examples, the at least one KMS includes a first KMS 111 (e.g., running on a first computing system 250) operatively coupled to the sender 101 and a second KMS 112 (e.g., running on the same first computing system 250 or a second computing system such as the computing system 250) operatively coupled to each of the plurality of receivers 102. The first KMS 111 and the second KMS 112 serve as a distributed service to the sender 101 and the plurality of receivers 102.

In some examples, the system of claim 1, wherein the counter X includes one of a number incremented by the sender 101, a random number, or a timestamp. In some examples, the DK is shared by the sender 101 and the plurality of receivers 102. In some examples, the DK is secured in a HSM of each of the at least one KMS. In some examples, each of the at least one KMS comprises Key Management Service (KMS).

In some examples, the IK is used the sender 101 or one or more of the plurality of receivers 102 to encrypt or decrypt local storage or database storage. In some examples, the each of the identifier of the sender 101 and the plurality of identifiers includes one or more of a username, account number, email address, device identifier, device identifier, or GUID.

In some examples, the at least one KMS (e.g., the KMS 111) is configured to derive a second transaction key using the IK and the counter corresponding to a second transaction and provide the second transaction key to the sender 101. The sender 101 encrypts a second message using the second transaction key and sends the encrypted second message and the counter to the plurality of receivers 102 via the network. In some examples, the at least one KMS (e.g., the KMS 111) is configured to derive the first transaction key using the IK and the received counter corresponding to the second transaction and provide the second transaction key to each of the plurality of receivers 102. Each of the plurality of receivers 102 decrypts the second message using the second transaction key.

As utilized herein, the terms “approximately,” “substantially,” and similar terms are intended to have a broad meaning in harmony with the common and accepted usage by those of ordinary skill in the art to which the subject matter of this disclosure pertains. It should be understood by those of ordinary skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

Although only a few arrangements have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative arrangements. Other substitutions, modifications, changes, and omissions may also be made in the design, operating conditions and arrangement of the various exemplary arrangements without departing from the scope of the present disclosure.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), a distributed ledger (e.g., a blockchain), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web arrangements of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

What is claimed is:

1. A system, comprising:
at least one Key Management Service (KMS), configured to:
derive an Initial Key (IK) using an identifier of a sender, a plurality of identifiers each corresponding to a respective one of a plurality of receivers, and a Domain Key (DK);
derive a first transaction key using the IK and a counter X corresponding to a first transaction and provide the first transaction key to the sender, wherein the sender encrypts a first message using the first transaction key and sends the encrypted first message and the counter to the plurality of receivers via a network;
derive, for each of the plurality of receivers, the IK using the identifier of the sender, the plurality of identifiers each corresponding to the respective one of the plurality of receivers, and the DK; and
derive the first transaction key using the IK and the received counter X corresponding to the first transaction and provide the first transaction key to each of the plurality of receivers, wherein each of the plurality of receivers decrypts the first message using the first transaction key.

2. The system of claim 1, wherein
the sender and the plurality of receivers are in a same domain; or
the sender and at least some of the plurality of receivers are in different domains.

3. The system of claim 1, wherein the at least one KMS comprises a single KMS operatively coupled to both the sender and the plurality of receivers, wherein the single KMS serves as a central service to the sender and the plurality of receivers.

4. The system of claim 1, wherein the at least one KMS comprises:
a first KMS operatively coupled to the sender; and
a second KMS operatively coupled to each of the plurality of receivers, wherein the first KMS and the second KMS serve as a distributed service to the sender and the plurality of receivers.

5. The system of claim 1, wherein the counter comprises one of a number incremented by the sender, a random number, or a timestamp.

6. The system of claim 1, wherein the DK is shared by the sender and the plurality of receivers.

7. The system of claim 1, wherein the DK is secured in a Hardware Security Module (HSM) of each of the at least one KMS.

8. The system of claim 1, wherein each of the at least one KMS comprises a Hardware Security Module (HSM).

9. The system of claim 1, wherein the IK is used the sender or one or more of the plurality of receivers to encrypt or decrypt local storage or database storage.

10. The system of claim 1, wherein each of the identifier of the sender and the plurality of identifiers comprises one or more of a username, account number, email address, device identifier, device identifier, or Globally Unique Identifier (GUID).

11. The system of claim 1, wherein
the at least one KMS is configured to:
derive a second transaction key using the IK and the counter corresponding to a second transaction and provide the second transaction key to the sender, wherein the sender encrypts a second message using the second transaction key and sends the encrypted second message and the counter to the plurality of receivers via the network; and
derive the first transaction key using the IK and the received counter corresponding to the second transaction and provide the second transaction key to each of the plurality of receivers, wherein each of the plurality of receivers decrypts the second message using the second transaction key.

12. A method, comprising:
deriving an Initial Key (IK) using an identifier of a sender, a plurality of identifiers each corresponding to a respective one of a plurality of receivers, and a Domain Key (DK);
deriving a first transaction key using the IK and a counter corresponding to a first transaction and provide the first transaction key to the sender, wherein the sender encrypts a first message using the first transaction key and sends the encrypted first message and the counter to the plurality of receivers via a network;
deriving, for each of the plurality of receivers, the IK using the identifier of the sender, the plurality of identifiers each corresponding to the respective one of the plurality of receivers, and the DK; and
deriving the first transaction key using the IK and the received counter corresponding to the first transaction and provide the first transaction key to each of the plurality of receivers, wherein each of the plurality of receivers decrypts the first message using the first transaction key.

13. The method of claim 12, wherein
the sender and the plurality of receivers are in a same domain; or
the sender and at least some of the plurality of receivers are in different domains.

14. The method of claim 12, wherein at least one Key Management Service (KMS)comprises a single KMS operatively coupled to both the sender and the plurality of receivers, wherein the single KMS serves as a central service to the sender and the plurality of receivers.

15. The method of claim 12, wherein at least one Key Management Service (KMS)comprises:
a first KMS operatively coupled to the sender; and
a second KMS operatively coupled to each of the plurality of receivers, wherein the first KMS and the second KMS serve as a distributed service to the sender and the plurality of receivers.

16. The method of claim 12, wherein the counter comprises one of a number incremented by the sender, a random number, or a timestamp.

17. The method of claim 12, wherein the DK is shared by the sender and the plurality of receivers.

18. The method of claim 12, wherein the DK is secured in a Hardware Security Module (HSM) of each of at least one Key Management Service (KMS).

19. The method of claim 12, wherein each of the at least one manager comprises Hardware Security Module (HSM).

20. At least one non-transitory processor-readable medium comprising processor -readable instructions, such that, when executed in one or more processors of a client, causes the one or more processors to:
derive an Initial Key (IK) using an identifier of a sender, a plurality of identifiers each corresponding to a respective one of a plurality of receivers, and a Domain Key (DK);
derive a first transaction key using the IK and a counter corresponding to a first transaction and provide the first transaction key to the sender, wherein the sender encrypts a first message using the first transaction key and sends the encrypted first message and the counter to the plurality of receivers via a network;
derive, for each of the plurality of receivers, the IK using the identifier of the sender, the plurality of identifiers each corresponding to the respective one of the plurality of receivers, and the DK; and
derive the first transaction key using the IK and the received counter corresponding to the first transaction and provide the first transaction key to each of the plurality of receivers, wherein each of the plurality of receivers decrypts the first message using the first transaction key.
